(19) United States
(12) Patent Application Publication
(10) Pub. No.: US 2011/0140564 A1
(43) Pub. Date: Jun. 16, 2011

(54) COIL SHEET, METHOD FOR MANUFACTURING COIL SHEET, COIL SHEET HOLDER, METHOD FOR ATTACHING COIL SHEET, ROTATOR OF MOTOR, AND MOTOR

(75) Inventors: Toshihiro Nomura, Ibi-gun (JP); Tetsuya Muraki, Ibi-gun (JP)

(73) Assignee: IBIDEN CO., LTD., Ogaki-shi (JP)

(21) Appl. No.: 12/788,405

(22) Filed: May 27, 2010

Related U.S. Application Data
(60) Provisional application No. 61/285,357, filed on Dec. 10, 2009.

(51) Int. Cl. H02K 3/04; H01F 5/00; H01F 41/04; H01F 27/30

(52) U.S. Cl. 310/208; 336/200; 29/605; 336/208

(57) ABSTRACT

A coil sheet has an insulative substrate which bends and has the first surface and the second surface on the opposite side of the first surface, a first conductor forming a first spiral conductive pattern and formed on the first surface of the insulative substrate, and a second conductor forming a second spiral conductive pattern and formed on the second surface of the insulative substrate. The width of the tip portion of the second conductor of the second spiral conductive pattern is set narrower than the width of the base end portion of the first conductor of the first spiral conductive pattern.

### CROSS-REFERENCE TO RELATED APPLICATIONS

The present application claims the benefits of priority to U.S. Application No. 61/285,357, filed Dec. 10, 2009. The contents of that application are incorporated herein by reference in their entirety.

### BACKGROUND OF THE INVENTION

1. Field of the Invention

The present invention relates to a coil sheet, a method for manufacturing a coil sheet, a coil sheet holder and a method for attaching a coil sheet, as well as to a motor rotor and a motor.

2. Discussion of the Background

In Japanese Laid-Open Patent Publication No. S54-67667, a coil sheet is described where a first conductive pattern and a second conductive pattern are formed on one side of an insulative substrate. The first conductive pattern and the second conductive pattern are connected in series in the coil sheet. Then, the coil sheet is bent at a bending portion between the first conductive pattern and the second conductive pattern.

In Japanese Laid-Open Patent Publication No. H10-289816, a coil sheet is described where a first conductive pattern and a second conductive pattern are formed on each surface (upper surface, lower surface) of an insulative substrate. The coil sheet is folded so that the axis of each conductive pattern will overlap.

In this application, the contents of Japanese Laid-Open Patent Publication Nos. S54-67667 and H10-289816 are incorporated by reference in their entirety.

### SUMMARY OF THE INVENTION

According to one aspect of the present invention, a coil sheet has an insulative substrate which bends and has the first surface and the second surface on the opposite side of the first surface, a first conductor forming a first spiral conductive pattern and formed on the first surface of the insulative substrate, and a second conductor forming a second spiral conductive pattern and formed on the second surface of the insulative substrate. The width of the tip portion of the second conductor of the second spiral conductive pattern is set narrower than the width of the base end portion of the first conductor of the first spiral conductive pattern.

According to another aspect of the present invention, a method for manufacturing a coil sheet includes preparing an insulative substrate which bends and has a first surface and a second surface on the opposite side of the first surface, and forming a first conductor forming a first spiral conductive pattern on the first surface of the insulative substrate and a second conductor forming a second spiral conductive pattern on the second surface of the insulative substrate such that the second conductor of the second spiral conductive pattern has a tip portion having the width which is set narrower than the width of a base end portion of the first conductor in the first spiral conductive pattern.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a plan view showing a first surface of a coil sheet according to the first embodiment;

FIG. 2 is a perspective view showing a second surface of a coil sheet according to the first embodiment seen from the first-surface side;

FIG. 3 is a view showing a cross-sectional configuration of a spiral pattern on a first-region side;

FIG. 4 is a view showing a cross-sectional configuration of a spiral pattern on a second-region side;

FIG. 5 is a magnified view of a spiral pattern;

FIG. 6 is a view showing a coil sheet while it is in use in the first embodiment;

FIG. 7 is a view showing a state of a coil sheet while in use;

FIG. 8 is a view showing a cross-sectional configuration of a coil sheet when it is bent;

FIG. 9 is a view showing a first comparative example of a coil sheet;

FIG. 10 is a view showing a second comparative example of a coil sheet;

FIG. 11 is a view to illustrate a step for preparing an insulative substrate;

FIG. 12 is a view to illustrate a step for forming seed layers;

FIG. 13 is a view to illustrate a step for forming resist layers;

FIG. 14 is a view to illustrate a step for forming electrolytic plated layers;

FIG. 15 is a view to illustrate a step for removing the resist layers;

FIG. 16 is a view to illustrate a step for removing the seed layers;

FIG. 17 is a view to illustrate an additional plating step;

FIG. 18 is a view schematically showing a motor according to the second embodiment;

FIG. 19 is a view to illustrate a step for forming an adhesive sheet on a coil sheet in a method for attaching a coil sheet according to the second embodiment;

FIG. 20 is a view to illustrate a step for inserting a support rod with an attached coil sheet into a core;

FIG. 21 is a view to illustrate a step for attaching a coil sheet to the inner surface of a core;

FIG. 22 is a view schematically showing a motor rotor according to the third embodiment;

FIG. 23 is a view to illustrate a method for attaching a coil sheet according to the third embodiment;

FIG. 24 is a view showing a first modified example of a plane configuration of a spiral pattern;

FIG. 25 is a view showing a second modified example of a plane configuration of a spiral pattern;

FIG. 26 is a view showing a third modified example of a plane configuration of a spiral pattern;

FIG. 27 is a view showing a first modified example of a cross-sectional configuration of a spiral pattern;

FIG. 28 is a view showing a second modified example of a cross-sectional configuration of a spiral pattern;

FIG. 29 is a view showing a third modified example of a cross-sectional configuration of a spiral pattern;

FIG. 30 is a view to illustrate a first step for forming a tapered side surface;

FIG. 31 is a view to illustrate a second step subsequent to the step in FIG. 30; and

FIG. 32 is a view to illustrate a third step subsequent to the step in FIG. 31.

### DETAILED DESCRIPTION OF THE EMBODIMENTS

The embodiments will now be described with reference to the accompanying drawings, wherein like reference numerals designate corresponding or identical elements throughout the various drawings.

In the drawings, arrows (Z1, Z2) each indicate a direction along a normal line (or a thickness direction of the substrate) to the main surfaces (upper and lower surfaces) of a substrate. Arrows (X1, X2) and (Y1, Y2) each indicate a direction parallel to the main surfaces of the substrate. The main surfaces of the substrate are on X-Y plane, and the side surfaces of the substrate are on X-Z plane or Y-Z plane. In the present embodiment, two main surfaces facing opposite normal lines are referred to as a first surface (the surface on arrow-Z1 side) and as a second surface (the surface on arrow-Z2 side). The conductor in a through hole is referred to as a through-hole conductor. A space factor is the percentage of space that conductors occupy in the cross section of a coil. Regarding a line pattern, a shorter measurement (the measurement in a direction perpendicular to the line) is referred to as “width” and a longer measurement (the measurement from one end of the line to the other end) is referred to as “length.” However, if clearly indicated otherwise, measurements are not limited to such definitions.

### First Embodiment

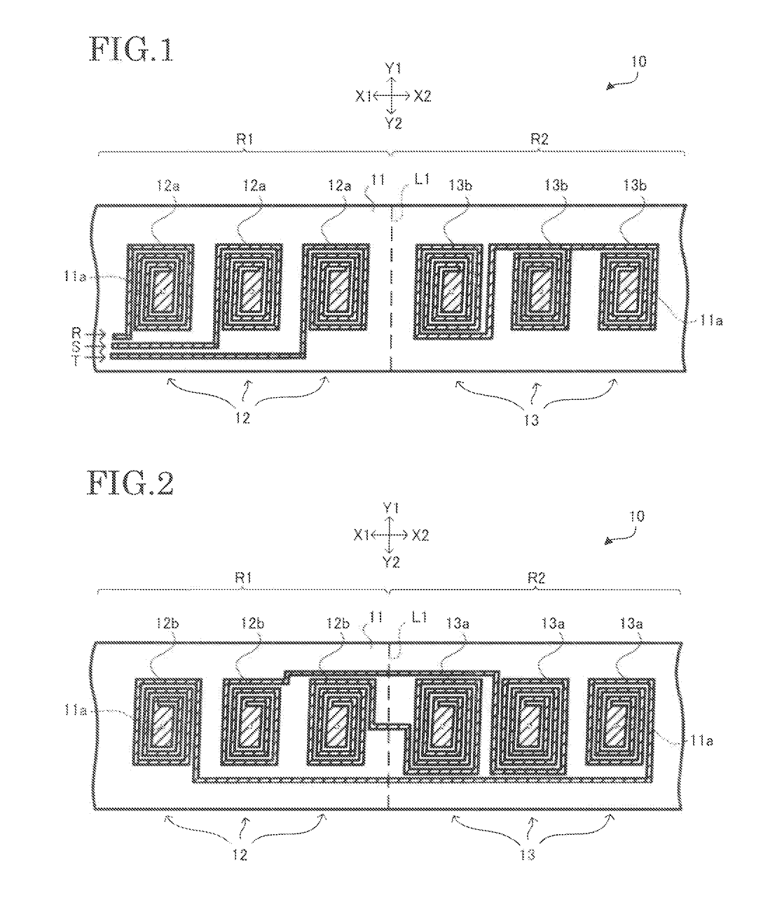

As shown in FIG. 1 (a plan view of a first surface) and FIG. 2 (a perspective view of a second surface seen from the first-surface side), coil sheet 10 of the present embodiment has insulative substrate 11 and spiral patterns (12, 13). Divided at line (L1) (border line) in insulative substrate 11, three spiral patterns 12 are positioned in first region (R1) on the (X1) side, and three spiral patterns 13 are positioned in second region (R2) on the (X2) side. Spiral patterns (12, 13) work as coils. Through-hole (11a) is formed in each center of conductive patterns (12a, 12b, 13a, 13b) which construct spiral patterns (12, 13). Moreover, to prevent peeling or short circuiting, a thin cover film made of polyester or polyimide may be formed on spiral patterns (12, 13).

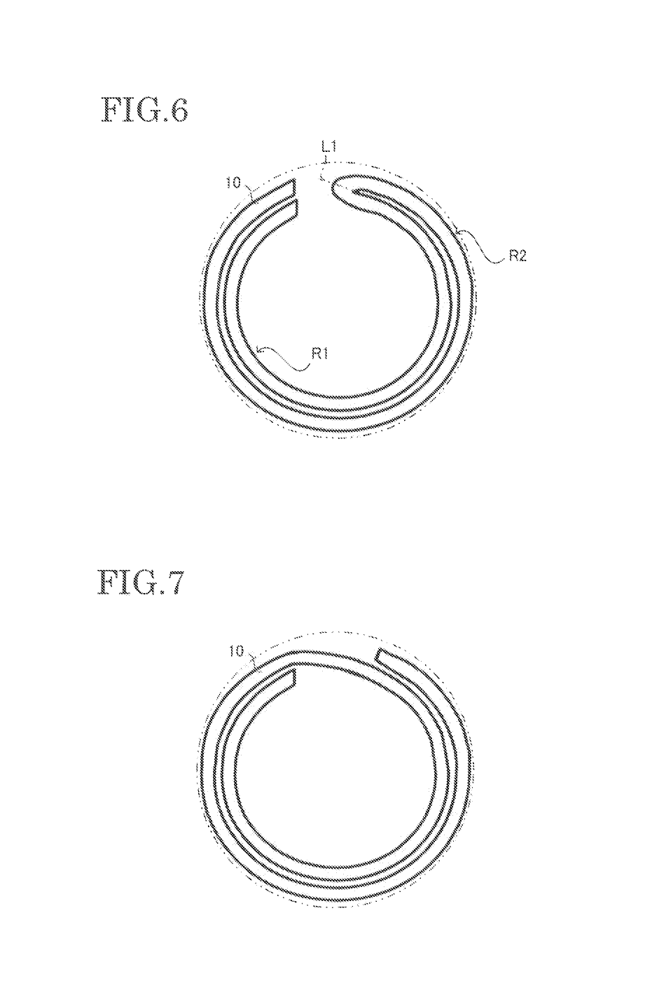

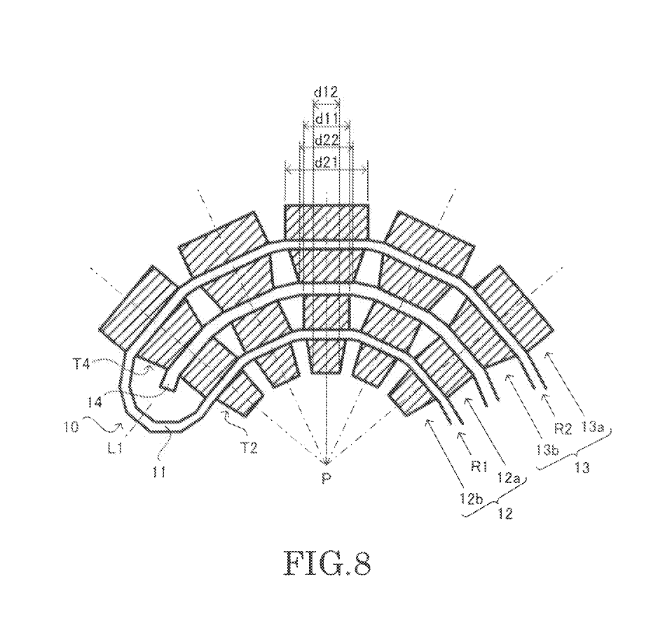

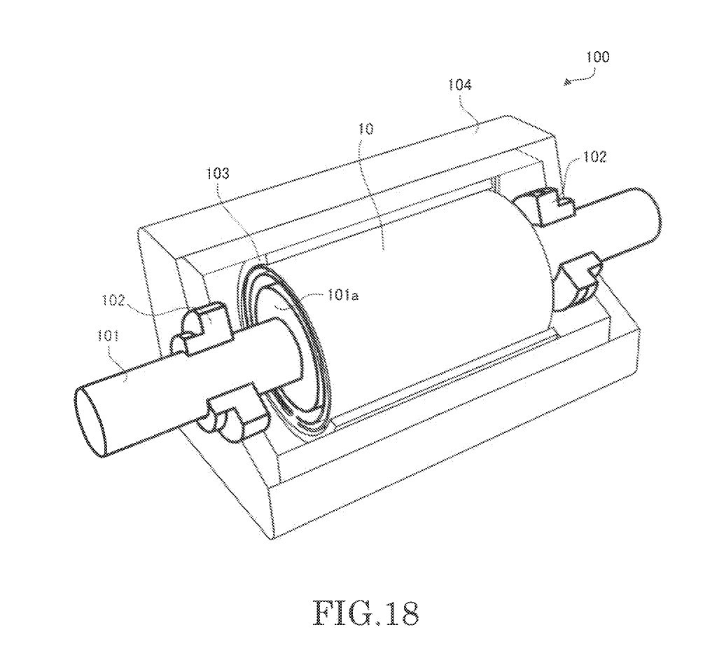

Coil sheet 10 may be bent or curved along directions X. When coil sheet 10 is folded at line (L1) and is bent or curved (see FIG. 6), three spiral patterns 12 are positioned at 120-degree intervals. Also, since conductors in spiral patterns 13 overlap the conductors in spiral patterns 12 (see FIG. 8), three spiral patterns 13 will also be positioned at 120-degree intervals. Therefore, a three-phase motor drive (such as motor 100 shown in FIG. 18) may be easily achieved with a sheet of coil sheet 10.

The distance between the centers of first conductive patterns (12a) is set shorter than the distance between the centers of fourth conductive patterns (13b). In the same manner, the distance between the centers of second conductive patterns (12b) is set shorter than the distance between the centers of third conductive patterns (13b). Moreover, as shown in FIG. 8, the distance in a width direction between the centers of the conductors that form each first conductive pattern (12a) is set shorter than the distance in a width direction between the centers of the conductors that form each fourth conductive pattern (13b). Likewise, the distance in a width direction between the centers of the conductors that form each second conductive pattern (12b) is set shorter than the distance in a width direction between the centers of the conductors that form each third conductive pattern (13a). Due to such a design, when coil sheet 10 is bent or curved, the conductors in spiral patterns 12 positioned on the inner side will overlap the conductors in spiral patterns 13 positioned on the outer side. As shown in FIG. 8, when coil sheet 10 is bent or curved, the distance between the centers of first conductive patterns (12a) is set, for example, approximately 700 μm shorter than the distance between the centers of fourth conductive patterns (13b). Likewise, the distance between the centers of second conductive patterns (12b) is set, for example, 700 μm shorter than the distance between the centers of third conductive patterns (13a). The distance in a width direction between the centers of the conductors that form each first conductive pattern (12a) is set, for example, approximately 50 μm shorter than the distance in a width direction between the centers of the conductors that form each fourth conductive pattern (13b). Likewise, the distance in a width direction between the centers of the conductors that form each second conductive pattern (12b) is set, for example, approximately 50 μm shorter than the distance in a width direction between the centers of the conductors that form each third conductive pattern (13a).

The material for and measurements of (especially the thicknesses of) insulative substrate 11, first conductive patterns (12a), second conductive patterns (12b), third conductive patterns (13a) and fourth conductive patterns (13b) are such that will allow them to be flexible.

Insulative substrate 11 is made of polyimide with a thickness of 10 μm, for example. Other than that, polyester or the like may also be used as a material for insulative substrate 11. Insulative substrate 11 is preferred to be thermosetting. If so, for example, after the insulative substrate is formed to be cylindrical, by curing it through thermal treatment, cylindrical insulative substrate 11 having highly accurate measurements may be easily obtained. However, the material for insulative substrate 11 is not limited to such, and any other material may also be used.

Spiral patterns (12, 13) are made of copper with a thickness of 150 μm, for example. Other than that, aluminum or the like may also be used as a material for spiral patterns (12, 13). However, the material for spiral patterns (12, 13) is not limited to those, and any other material may be used.

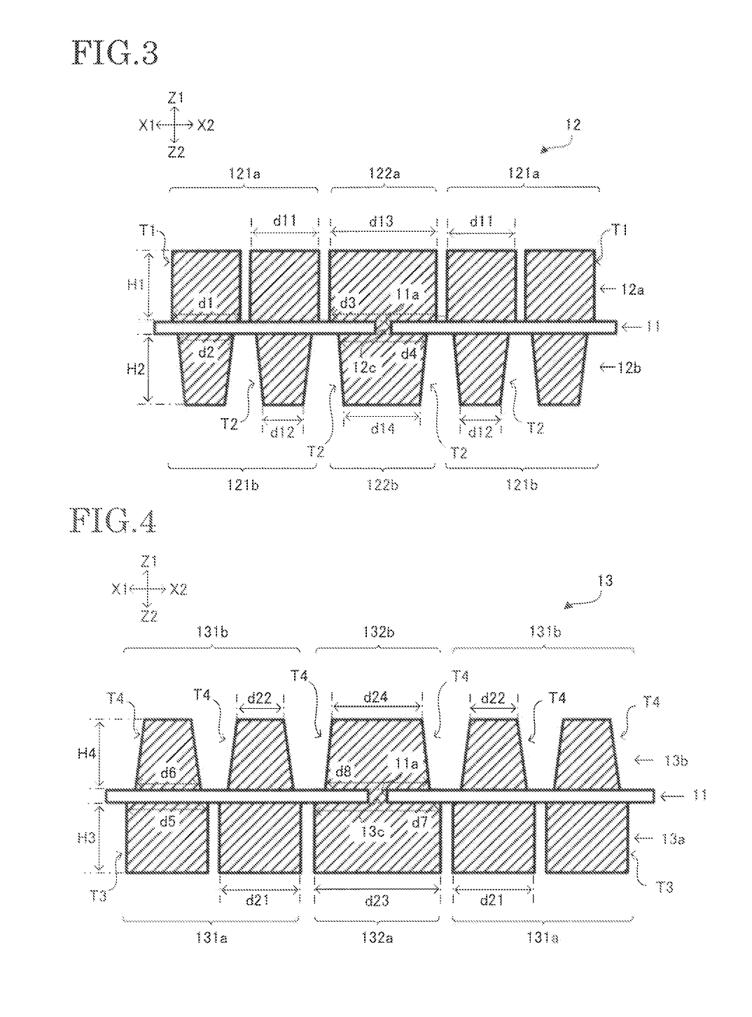

FIG. 3 shows a cross-sectional configuration of spiral pattern 12. Spiral pattern 12 is formed with first conductive pattern (12a), second conductive pattern (12b) and through-hole conductor (12c). First conductive pattern (12a) is formed on the first surface of insulative substrate 11, and second conductive pattern (12b) is formed on the second surface of insulative substrate 11. Through-hole conductor (12c) is formed in through hole (11a). First conductive pattern (12a) has spiral section (121a) and central section (122a), and second conductive pattern (12b) has spiral section (121b) and central section (122b). Line widths of spiral sections (121a, 121b) and distances between the lines are set substantially the same. Therefore, in spiral sections (121a, 121b), conductive lines with a constant width are positioned at a constant distance. The conductors in first conductive pattern (12a) and the conductors in second conductive pattern (12b) face each other by sandwiching insulative substrate 11, and first conductive pattern (12a) and second conductive pattern (12b) are connected to each other at central sections (122a, 122b) by means of through-hole conductor (12c).

In first conductive pattern (12a), the height of the conductors in spiral section (121a) is set substantially equal (H1) to the height of the conductor in central section (122a). Also, width (d11) at the tip of a conductor included in spiral section (121a) is set substantially the same as width (d1) at the base end of the conductor (d11=d1). Likewise, width (d13) at the tip of a conductor included in central section (122a) is set substantially the same as width (d3) at the base end of the conductor (d13=d3). Namely, the conductors included in first conductive pattern (12a) have substantially the same width from the base end (on the side of insulative substrate 11) to the tip. Then, side surfaces (T1) of the conductors in first conductive pattern (12a) are set substantially perpendicular to the main surfaces of insulative substrate 11. In the present application, the base end of a conductor indicates an edge of the conductor which makes contact with insulative substrate 11 in the height direction of the conductor (arrows (Z1, Z2) in FIG. 3), and the tip of a conductor indicates the edge of the conductor which is located at the farthest point from insulative substrate 11 in the height direction of the conductor.

On the other hand, in second conductive pattern (12b), the height of the conductors in spiral section (121b) is set substantially equal (H2) to the height of the conductor in central section (122b). Width (d12) at the tip of a conductor included in spiral section (121b) is set narrower than width (d2) at the base end of the conductor (d12<d2). Likewise, width (d14) at the tip of a conductor included in central section (122b) is set narrower than width (d4) at the base end of the conductor (d14<d4). Namely, side surfaces (T2) of the conductors in second conductive pattern (12b) incline inward from the base end toward the tip, and a pair of facing side surfaces (T2) taper symmetrically.

When first conductive pattern (12a) and second conductive pattern (12b) are compared, width (d2) at the base end of a conductor in spiral section (121b) is set narrower than width (d1) at the base end of a conductor in spiral section (121a) (d2<d1). Likewise, width (d4) at the base end of a conductor in central section (122b) is set narrower than width (d3) at the base end of a conductor in central section (122a) (d4<d3). Therefore, in the present embodiment, width (d12) at the tip of a conductor in second conductive pattern (12b) is set narrower than width (d1) at the base end of a conductor in first conductive pattern (12a).

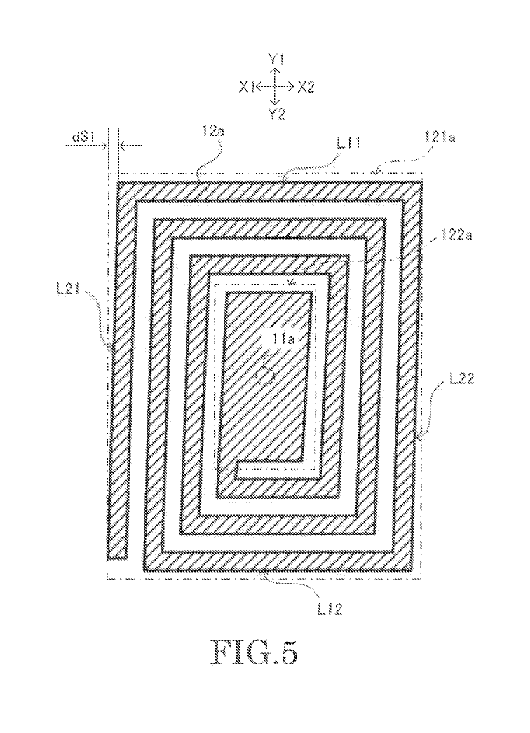

FIG. 4 shows a cross-sectional configuration of spiral pattern 13. Spiral pattern 13 is formed with third conductive pattern (13a), fourth conductive pattern (13b) and through-hole conductor (13c). Third conductive pattern (13a) is formed on the second surface of insulative substrate 11, and fourth conductive pattern (13b) is formed on the first surface of insulative substrate 11. Through-hole conductor (13c) is formed in through hole (11a). Third conductive pattern (13a) has spiral section (131a) and central section (132a), and fourth conductive pattern (13b) has spiral section (131b) and central section (132b). Line widths of spiral sections (131a, 131b) and distances between the lines are substantially the same. Therefore, in spiral sections (131a, 131b), conductive lines with a constant width are positioned at a constant distance. The conductors in third conductive pattern (13a) and the conductors in fourth conductive pattern (13b) face each other by sandwiching insulative substrate 11, and third conductive pattern (13a) and fourth conductive pattern (13b) are connected to each other at central sections (132a, 132b) by means of through-hole conductor (13c).

In third conductive pattern (13a), the height of conductors in spiral section (131a) is set substantially equal (H3) to the height of the conductor in central section (132a). Also, width (d21) at the tip of a conductor included in spiral section (131a) is set substantially the same as width (d5) at the base end of the conductor (d21=d5). Likewise, width (d23) at the tip of a conductor included in central section (132a) is set substantially the same as width (d7) at the base end of the conductor (d23=d7). Namely, conductors included in third conductive pattern (13a) have substantially the same width from the base end (on the side of insulative substrate 11) to the tip. Then, side surfaces (T3) of the conductors in third conductive pattern (13a) are set substantially perpendicular to the main surfaces of insulative substrate 11.

On the other hand, in fourth conductive pattern (13b), the height of the conductors in spiral section (131b) is set substantially equal (H4) to the height of the conductor in central section (132b). Width (d22) at the tip of a conductor included in spiral section (131b) is set narrower than width (d6) at the base end of the conductor (d22<d6). Likewise, width (d24) at the tip of a conductor included in central section (132b) is set narrower than width (d8) at the base end of the conductor (d24<d8). Namely, side surfaces (T4) of the conductors in fourth conductive pattern (13b) incline inward from the base end toward the tip, and a pair of facing side surfaces (T4) taper symmetrically.

When third conductive pattern (13a) and fourth conductive pattern (13b) are compared, width (d6) at the base end of a conductor in spiral section (131b) is set narrower than width (d5) at the base end of a conductor in spiral section (131a) (d6<d5). Likewise, width (d8) at the base end of the conductor in central section (132b) is set narrower than width (d7) at the base end in the central section (132a) (d8<d7). Therefore, in the present embodiment, width (d22) at the tip of a conductor in fourth conductive pattern (13b) is narrower than width (d5) at the base end of a conductor in third conductive pattern (13a).

In the present embodiment, widths are set in the order of d12<d11<d22<d21 (see FIG. 8). Likewise, widths are set in the order of d14<d13<d24<d23. In the present embodiment, for example, the value of width (d11) is set at 450 μm, the value of width (d12) is set at 430 μm, the value of width (d13) is set at 500 μm, and the value of width (d14) is set at 480 μm. Also, the value of width (d21) is set at 510 μm, the value of width (d22) is set at 475 μm, the value of width (d23) is set at 545 μm, and the value of width (d24) is set at 525 μm. However, the value of the width of each conductor is not limited to the above values, and may be set freely according to usage requirements or the like as long as they are within a range that keeps the size relationship of each width.

In the present embodiment, the heights are set as H1=H2=H3=H4. However, the value of the height of each conductor is not limited to any value that satisfies such a relational equation, and may be set freely according to usage requirements or the like.

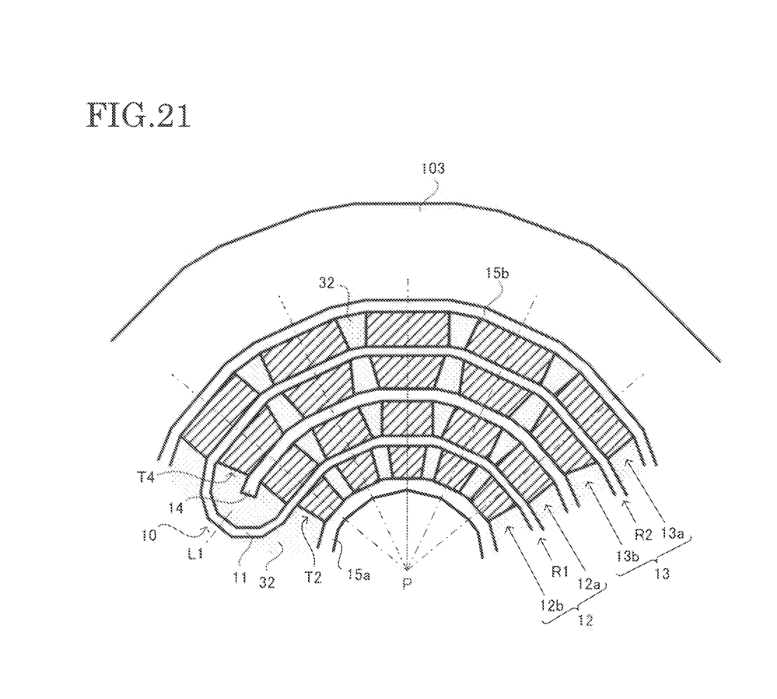

FIG. 5 shows a magnified view of spiral pattern 12. The configuration of spiral pattern 12 is set to be substantially a parallelogram. Two sides (first sides (L11, L12)) of the parallelogram are parallel to bending or curving directions (directions X), while the other two sides (second sides (L21, L22)) incline in directions perpendicular to the bending or curving directions (directions Y). Namely, second sides (L21, L22) do not intersect with bending or curving directions at a right angle. The amount (d31) that second sides (L21, L22) incline toward directions Y is set to be more than the distance between the conductors in spiral pattern 12 (for example, 70 μm or more). In doing so, when insulative substrate 11 is bent or curved, the hardness of coil sheet 10 due to conductors will become the same in areas where spiral patterns 12 are formed in coil sheet 10. Accordingly, creases are seldom formed in such areas of insulative substrate 11, allowing insulative substrate 11 to be smoothly bent or curved. As a result, attaching coil sheet 10 on the inner surface of a holder (such as core 103 shown in FIG. 21) will become easier. Spiral patterns 13 have the same configuration.

It is preferred to use coil sheet 10 by folding it in two at line (L1) and rolling it into a circle as shown in FIG. 6. In such a state, coil sheet 10 becomes double-layered so that first region (R1) and second region (R2) will overlap. As shown in FIG. 7, coil sheet 10 may be used by being rolled twice without being folded. However, compared with a case in which a coil sheet is double-layered without being folded, coil sheet 10 will spread out easily if coil sheet 10 is folded at line (L1) and becomes double-layered (laminated), and a better result is achieved when coil sheet 10 is attached to a holder (such as core 103 shown in FIG. 21). Moreover, uneven surfaces will be suppressed from occurring. As shown in FIG. 8, when coil sheet 10 is bent or curved, third conductive pattern (13a), fourth conductive pattern (13b), first conductive pattern (12a) and second conductive pattern (12b) will be positioned in that order from the outer side toward the inner side. Then, the conductors in those conductive patterns will be positioned at substantially the same angle to center (P) of circles which correspond to the curve. Also, adhesive sheet 14 is arranged between the laminated portions of coil sheet 10. Then, an adhesive agent is applied between coil sheet 10 and adhesive sheet 14.

Coil sheet 1000 has two insulative substrates (1001, 1002) as shown in FIG. 9. Conductive pattern (1001a) is formed on one surface of insulative substrate 1001, and conductive pattern (1002a) is formed on one surface of insulative substrate 1002. The conductors in conductive patterns (1001a, 1002a) have substantially the same width from the base end to the tip. Those conductors are positioned on insulative substrates (1001, 1002) at a constant interval. When insulative substrates (1001, 1002) are each bent or curved and then bent or curved insulative substrates (1001, 1002) are laminated, it is thought that the positions of the conductors in conductive pattern (1001a) and the conductors in conductive pattern (1002a) will be out of alignment in relation to center (P) of the circles corresponding to the curve formed by insulative substrates (1001, 1002), as shown in FIG. 9. Therefore, when coil sheet 1000 is used by being rolled on the surface (curved surface) of a cylindrical rod, for example, it is difficult to improve the space factor of coil sheet 1000.

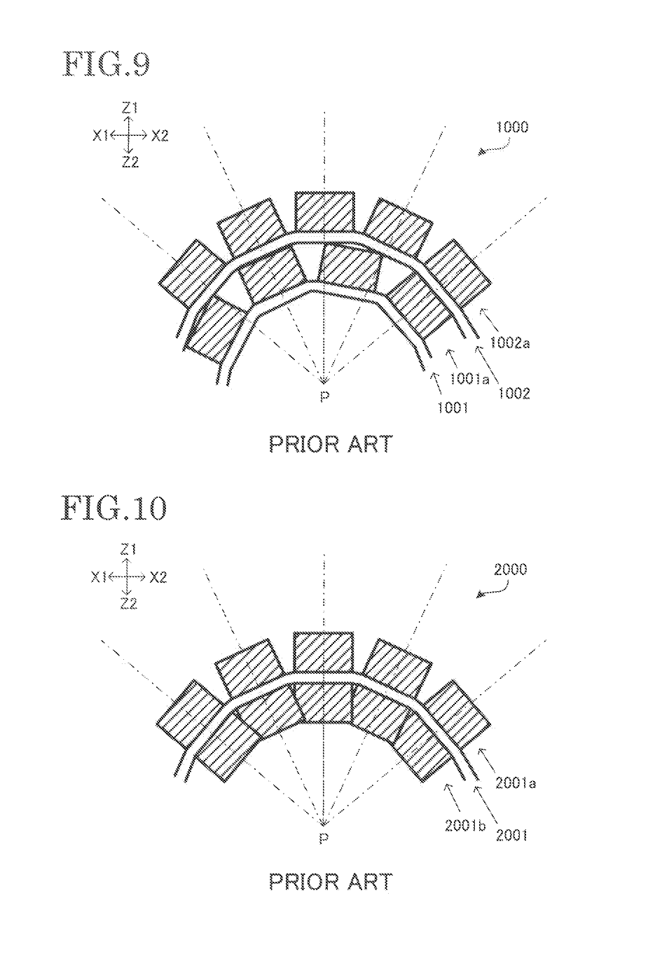

On the other hand, coil sheet 2000 has insulative substrate 2001 and conductive patterns (2001a, 2001b) as shown in FIG. 10. Conductive pattern (2001a) is formed on the first surface of insulative substrate 2001, and conductive pattern (2001b) is formed on the second surface of insulative substrate 2001. The conductors in conductive patterns (2001a, 2001b) have substantially the same width from the base end to the tip. Those conductors are positioned on insulative substrate 2001 at a constant interval. Conductive pattern (2001a) and conductive pattern (2001b) face each other by sandwiching insulative substrate 2001. If insulative substrate 2001 is bent or curved when using such coil sheet 2000, there is a risk that adjacent conductors will touch each other in conductive pattern (2001b) positioned on the inner side, as shown in FIG. 10. Accordingly, when coil sheet 2000 is used by rolling it on the surface (curved surface) of a cylindrical rod, for example, it is difficult to improve the space factor of coil sheet 2000.

In coil sheet 10 of the present embodiment, conductors in first conductive pattern (12a) and conductors in second conductive pattern (12b), along with conductors in third conductive pattern (13a) and conductors in fourth conductive pattern (13b) face each other by sandwiching insulative substrate 11. Accordingly, when coil sheet 10 is bent or curved, conductors included in third conductive pattern (13a), fourth conductive pattern (13b), first conductive pattern (12a) and second conductive pattern (12b) will overlap as shown in FIG. 8. Those conductors are positioned at substantially the same angle to center (P) of the circle that corresponds to the curve, and will seldom be out of alignment with each other. As a result, the magnetic power of the coil will increase. In addition, conductors included in second conductive pattern (12b) and fourth conductive pattern (13b), which are positioned on the inner side, become narrower toward the inner side (becoming closer to center (P)) due to tapered side surfaces (T2, T4). Therefore, when insulative substrate 11 is bent or curved, adjacent conductors in second conductive pattern (12b) and fourth conductive pattern (13b) may seldom touch each other. Moreover, without widening the intervals when arranging conductors, short circuits may be suppressed from occurring in adjacent conductors. Accordingly, in coil sheet 10 of the present embodiment, the space factor is improved compared with above coil sheets (1000, 2000).

In coil sheet 10 of the present embodiment, the conductors in first conductive pattern (12a) and third conductive pattern (13a) formed on one of the main surfaces of insulative substrate 11 have side surfaces (T1, T3), which are set substantially perpendicular to the main surfaces of insulative substrate 11. The cross-sectional configuration of the conductors in first conductive pattern (12a) and third conductive pattern (13a) is set to have four sides. As described, side surfaces (T2, T4) of the conductors taper only in second conductive pattern (12b) and fourth conductive pattern (13b) which will be positioned on the inner side when the sheet is bent or curved; and side surfaces (T1, T3) of the conductors do not taper in first conductive pattern (12a) and third conductive pattern (13a) which will be positioned on the opposite side. Therefore, an enhanced space factor is achieved in coil sheet 10.

As shown in FIG. 1, in the circuits of coil sheet 10 formed by spiral patterns (12, 13), three-phase (R, S, T) wires are each set in a delta connection. As shown in FIGS. 1 and 2, when seen from the first-surface side, three-phase (R, S, T) currents that are input each flow clockwise from spiral section (121a) (FIG. 3) toward central section (122a) (FIG. 3), then flow from the first surface toward the second surface at central sections (122a, 122b), and the currents that are output from central section (122b) flow clockwise again in spiral section (121b). Namely, in first region (R1), currents flow clockwise. After that, however, when currents flow from second conductive pattern (12b) toward third conductive pattern (13a), three-phase (R, S, T) currents each flow counterclockwise from spiral section (131a) (FIG. 4) toward central section (132a) (FIG. 4), then flow from the second surface toward the first surface at central sections (132a, 132b), and the currents which are output from central section (132b) flow counterclockwise again in spiral section (131b). Namely, in second region (R2), currents flow counterclockwise. Accordingly, by folding such coil sheet 10 at line (L1) and laminating first region (R1) and second region (R2), currents will flow in the same direction (for example, clockwise) in both spiral patterns (12, 13). As a result, higher magnetic power will be achieved. Therefore, coil sheet 10 is suitable for a three-phase motor drive.

Coil sheet 10 is manufactured using the following method, for example.

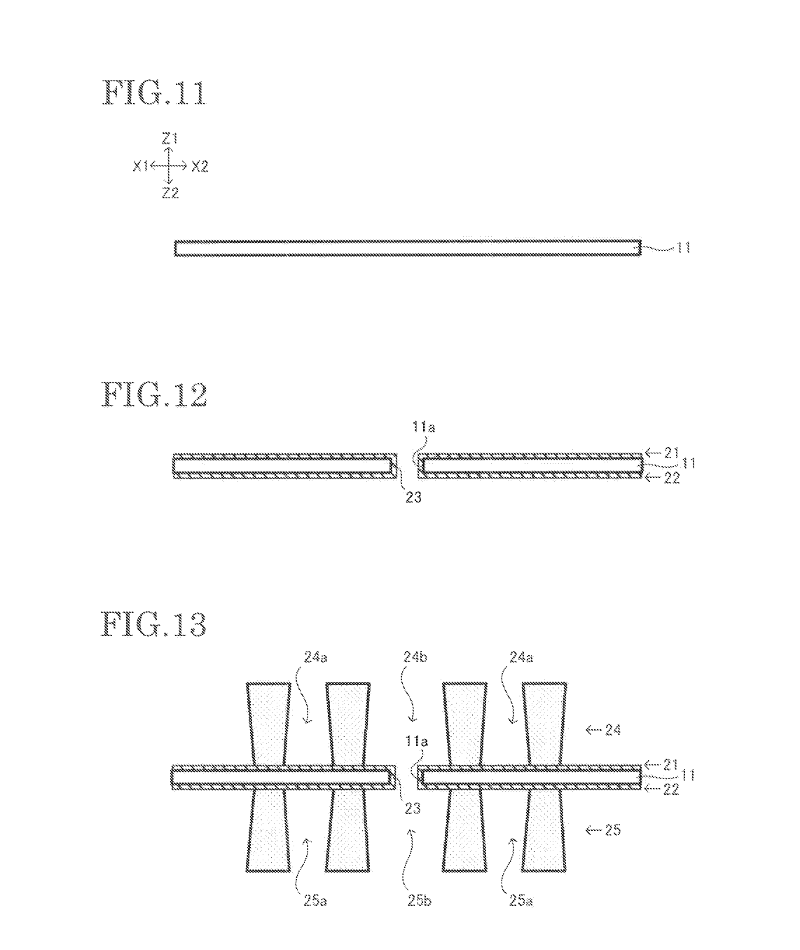

First, insulative substrate 11 is prepared as shown in FIG. 11. Then, as shown in FIG. 12, through hole (11a) is formed in insulative substrate 11 by boring using a laser or a drill, for example. Next, by performing electroless copper plating, for example, first seed layer 21 is formed on the first surface of insulative substrate 11, second seed layer 22 on the second surface of insulative substrate 11, and third seed layer 23 on the wall surface of through hole (11a). As for a material for first to third seed layers (21-23), nickel, titanium, chrome or the like may also be used. In addition, first to third seed layers (21-23) are not limited to electroless plated film, and may be sputtered film or CVD film, for example.

Next, as shown in FIG. 13, resist layer 24 (plating resist) is formed on the first surface of insulative substrate 11, and resist layer 25 (plating resist) is formed on the second surface of insulative substrate 11. The height of resist layer 24 is, for example, 120 μm or 150 μm. Resist layer 24 has spiral-shaped opening portions (24a) and opening portion (24b) which corresponds to the center of the spiral shape. Also, resist layer 25 has spiral-shaped opening portions (25a) and opening portion (25b) which corresponds to the center of the spiral shape. The widths of resist layers (24, 25) are each set to become wider from the base end (the side of insulative substrate 11) toward the tip (away from insulative substrate 11). Resist layers (24, 25) having such a configuration may be formed by using a negative-type resist. Namely, if resist layers (24, 25) are negative-type resist, for example, the etching amount is greater at the tip side (surface) than at the base-end side in a photolithographic process because areas closer to the base end are harder to expose to light. As a result, resist layers (24, 25) are obtained having the above configuration.

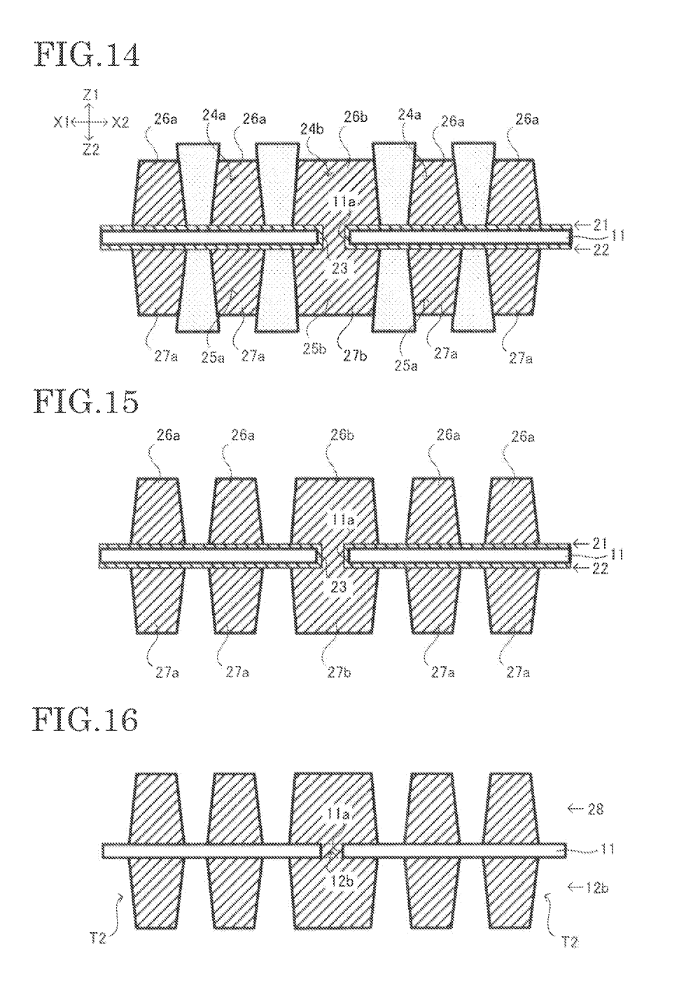

Next, electrolytic copper plating is performed, for example. In doing so, as shown in FIG. 14, electrolytic plated layer (26a) is formed in opening portions (24a); electrolytic plated layer (26b) is formed in opening portion (24b); electrolytic plated layer (27a) is formed in opening portions (25a); and electrolytic plated layer (27b) is formed in opening portion (25b). After that, as shown in FIG. 15, resist layers (24, 25) are removed by using a removing solution, for example.

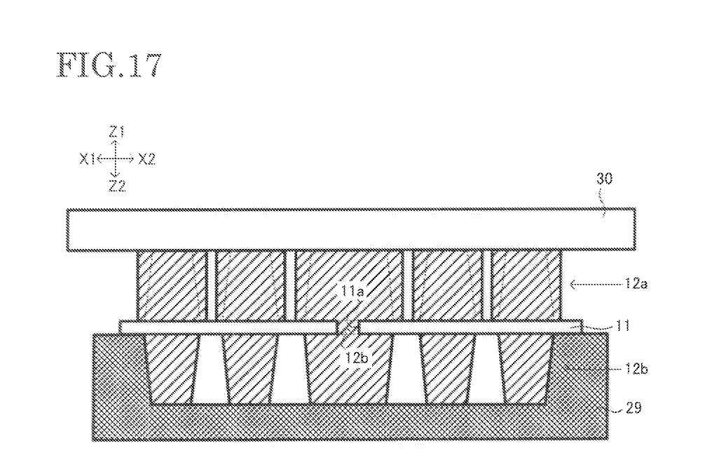

Next, as shown in FIG. 16, by etching, for example, first seed layer 21 and second seed layer 22 which were underneath resist layers (24, 25) are removed. In doing so, adjacent conductors will be electrically separated from each other. As a result, conductive pattern 28 is formed on the first surface of insulative substrate 11, and second conductive pattern (12b) is formed on the second surface of insulative substrate 11. Conductive pattern 28 is a conductive pattern before side surfaces are configured in the conductors included in first conductive pattern (12a). Side surfaces of the conductors included in conductive pattern 28 will taper. Side surfaces of the conductors included in second conductive pattern (12b) will also taper, inclining inward from the base end toward the tip.

Next, as shown in FIG. 17, resist 29 is formed to cover the second-surface side of second conductive pattern (12b). Moreover, porous board 30 is positioned on first conductive pattern (12a) (on the first-surface side). Then, while maintaining such a condition, electrolytic plated film is added onto the first-surface side of conductive pattern 28 by performing electrolytic copper plating, for example. During that time, electrolytic plated film will not be formed on areas covered by porous board 30. Thus, the heights in first conductive pattern (12a) may be easily set the same. Accordingly, first conductive pattern (12a) is formed. Side surfaces of the conductors included in first conductive pattern (12a) are set substantially perpendicular to the main surfaces of insulative substrate 11.

During such plating process, if first conductive pattern (12a) is thick, for example, 150 μm, electric fields will concentrate at the tip portion of the conductors in first conductive pattern (12a). Thus, electrolytic plated film will be formed mainly on side surfaces at the tip portion of the conductors in first conductive pattern (12a). However, electrolytic plated film will also be formed a little on side surfaces at the base-end portion of the conductors in first conductive pattern (12a). Therefore, widths (d1, d3) (FIG. 3) at the base end of conductors in first conductive pattern (12a) become wider than widths (d2, d4) (FIG. 3) at the base end of conductors in second conductive pattern (12b).

After that, resist 29 and porous board 30 are removed, and cover film or the like is formed if required. Forming first conductive pattern (12a) and second conductive pattern (12b) are described above. When first conductive pattern (12a) and second conductive pattern (12b) are formed, third conductive pattern (13a) and fourth conductive pattern (13b) are also formed using the same method.

Next, insulative substrate 11 is folded in two at line (L1), for example. At that time, adhesive sheet 14 is arranged between the laminated portions of coil sheet 10. An adhesive agent is applied between coil sheet 10 and adhesive sheet 14. As a result, first region (R1) and second region (R2) of coil sheet 10 are laminated and adhered, becoming double-layered. After that, laminated coil sheet 10 is rolled into a cylindrical shape, and the cylindrical laminated coil sheet is completed as shown earlier in FIG. 8.

The manufacturing method of the present embodiment is suitable for manufacturing coil sheet 10. Using such a manufacturing method, an excellent coil sheet 10 is obtained at a lower cost.

### Second Embodiment

In the present embodiment, as shown in FIG. 18, motor 100 for industrial robots, for example, is manufactured by using coil sheet 10 of the first embodiment. Motor 100 is a three-phase motor drive. The type of motor or motor usage is not limited specifically. For example, spindle motors for disc drive may also be manufactured. Also, the connection type for the circuits of coil sheet 10 is not limited to a delta connection, and Y connections, V connections or other connections may also be used. Motor 100 is not limited to a three-phase motor drive, and may also be a single-phase motor drive.

Motor 100 of the present embodiment has coil sheet 10, cylindrical-rod-shaped rotating shaft 101, rotor (101a) (magnet), bearing 102 of rotating shaft 101, cylindrical core 103 (holding member) and casing 104. Rotating shaft 101 is attached to rotor (101a). The surface of rotor (101a) is magnetized. Coil sheet 10 is attached to the inner surface of core 103. While it is folded to be double-layered or more, coil sheet 10 is bent or curved along the inner surface of core 103. A stator is formed with coil sheet 10, core 103 and others.

Coil sheet 10 will be attached to core 103 by the following method, for example.

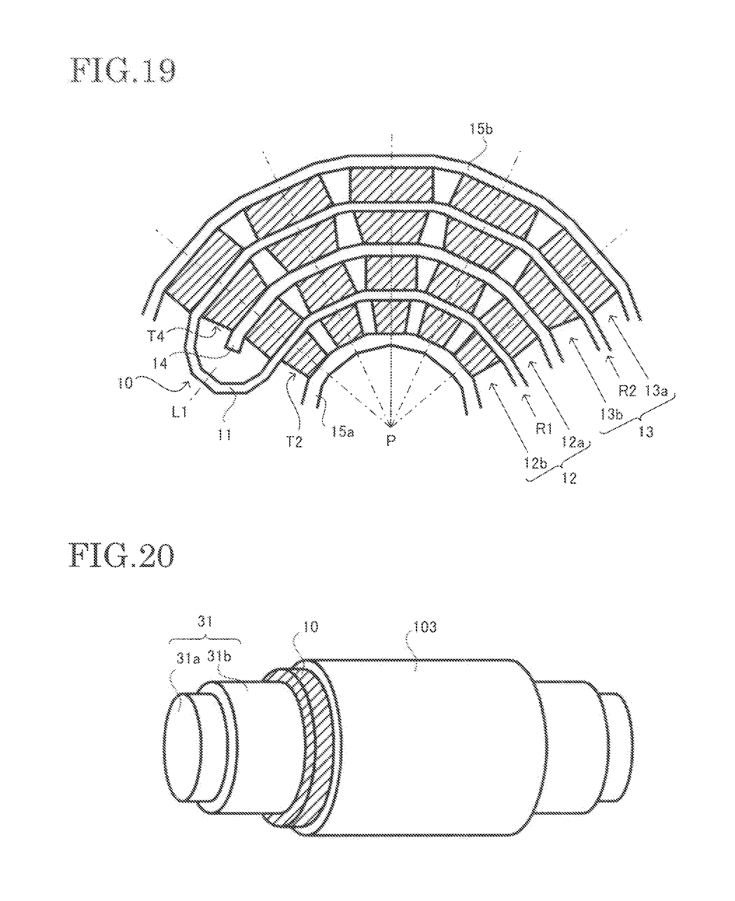

As shown in FIG. 19, for example, cover film (15a) is formed on the inner side of coil sheet 10, and forms adhesive sheet (15b) on the outer side of coil sheet 10.

Next, as shown in FIG. 20, support rod 31 having stainless-steel rod (31a) and fluororesin sheet (31b) is prepared. Sheet (31b) is thermally expandable, and is rolled around rod (31a). Next, coil sheet 10 is rolled around the surface of sheet (31b). In addition, adhesive agent 32 (see FIG. 21) is applied on the outer surface (adhesive sheet (15b)) of coil sheet 10, and inserts support rod 31 with rolled coil sheet 10 into core 103.

Next, support rod 31 and other parts are heated. By doing so, sheet (31b) thermally expands. As a result, as shown in FIG. 21, coil sheet 10 is pressed against the inner surface of core 103 by the expansion force of sheet (31b). Also, adhesive agent 32 is cured by heat and coil sheet 10 is adhered to the inner surface of core 103. Next, after cooling support rod 31, support rod 31 is removed from core 103.

Motor 100 is completed by assembling into casing 104 above rotor (101a) and other parts, along with core 103 and coil sheet 10 integrated as above.

In the manufacturing method of the present embodiment, since sheet (31b) spreads out to substantially become completely round due to thermal expansion, coil sheet 10 may be easily pressed against the entire inner surface of core 103. As a result, less adhesive agent 32 is required to adhere coil sheet 10 to the inner surface of core 103. Accordingly, the space factor of coil sheet 10 may increase.

The method for attaching a coil sheet according to the present embodiment is suitable for manufacturing motor 100. Using such a manufacturing method, an excellent motor 100 is obtained at a lower cost.

### Third Embodiment

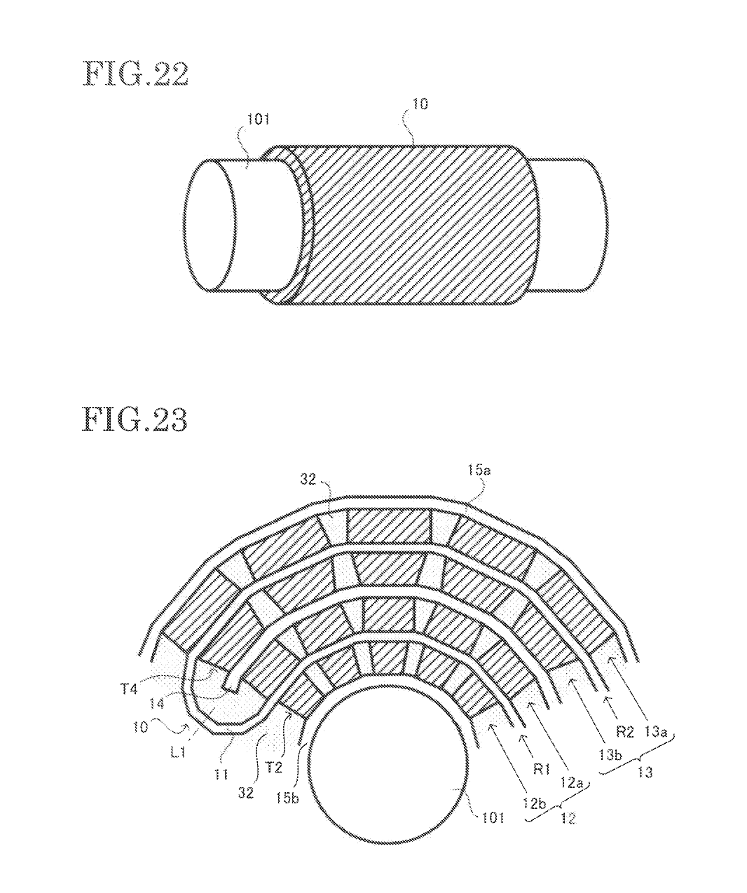

In the second embodiment, an example is shown to attach coil sheet 10 to core 103. In the present embodiment, as shown in FIG. 22, coil sheet 10 is attached to the external surface of rotating shaft 101. By doing so, a motor rotor is obtained. In such an example, as shown in FIG. 23, for example, by arranging adhesive sheet (15b) on the inner side of coil sheet 10, and applying adhesive agent 32 between adhesive sheet (15b) and rotating shaft 101, coil sheet 10 and rotating shaft 101 may be adhered and integrated.

By inserting such a rotor into a cylindrical stator core (cylindrical member) and then by assembling them into a predetermined casing, a motor which is equivalent to above-described motor 100 (FIG. 18) is manufactured.

### Other Embodiments

The configuration of spiral patterns (12, 13) is not limited to that shown in FIG. 5 as an example.

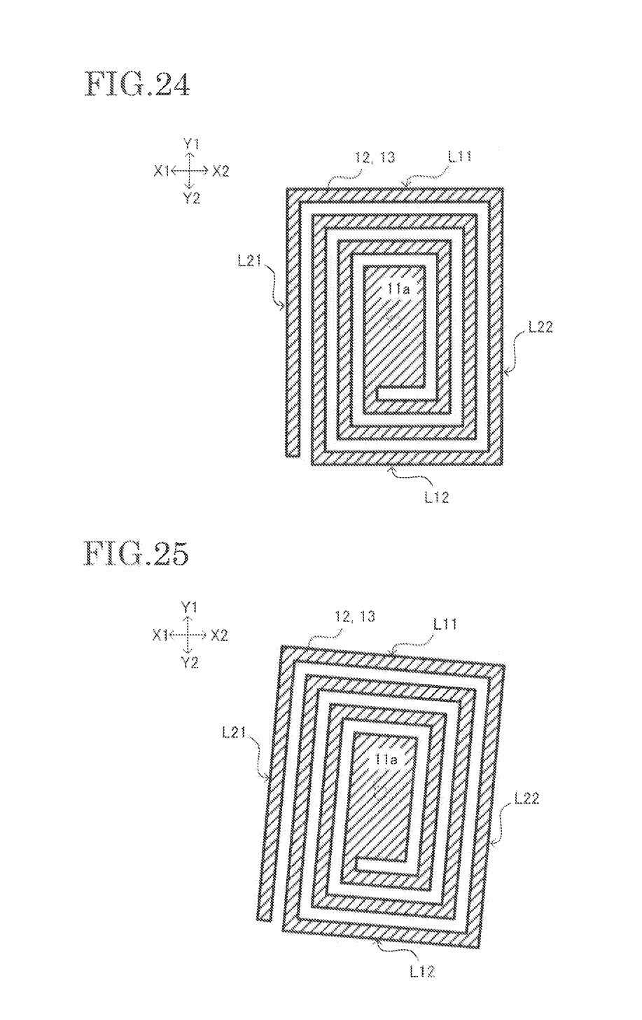

In spiral patterns (12, 13), second sides (L21, L22) are not required to be inclined. For example, as shown in FIG. 24, it is also acceptable for first sides (L11, L12) to be parallel to directions X (the bending or curving direction) and second sides (L21, L22) to be parallel to directions Y. Alternatively, as shown in FIG. 25, it is also acceptable for first sides (L11, L12) not to be parallel to directions X (the bending or curving direction) and second sides (L21, L22) not to be parallel to directions Y.

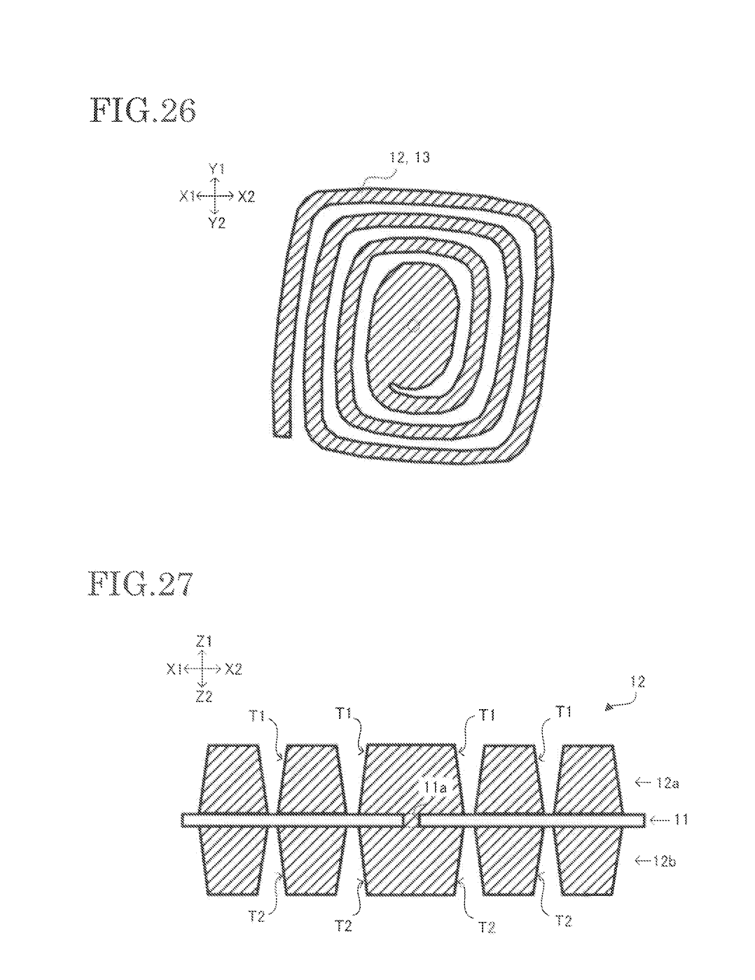

In addition, the shape of spiral patterns (12, 13) is not limited to rectangular or parallelogram spiral. For example, as shown in FIG. 26, the spiral shape may be even closer to a circle. Alternatively, the shape may be formed by rounding only the corners of the above rectangular or parallelogram spiral.

As shown in FIG. 27, in spiral pattern 12, conductors in first conductive pattern (12a) and conductors in second conductive pattern (12b) formed on the first surface and second surface of insulative substrate 11 may each have side surfaces (T1, T2) which incline inward from the base end toward the tip. The same applies to spiral pattern 13.

As shown in FIG. 28, in spiral pattern 12, the conductors in first conductive pattern (12a) (especially spiral section (121a)) and the conductors in second conductive pattern (12b) (especially spiral section (121b)) may not be required to face each other. Compared with cases in which the conductors in second conductive pattern (12b) are not tapered, by tapering the conductors in second conductive pattern (12b), effects such as an enhanced space factor may be expected when coil sheet 10 is bent or curved. The same applies to spiral pattern 13.

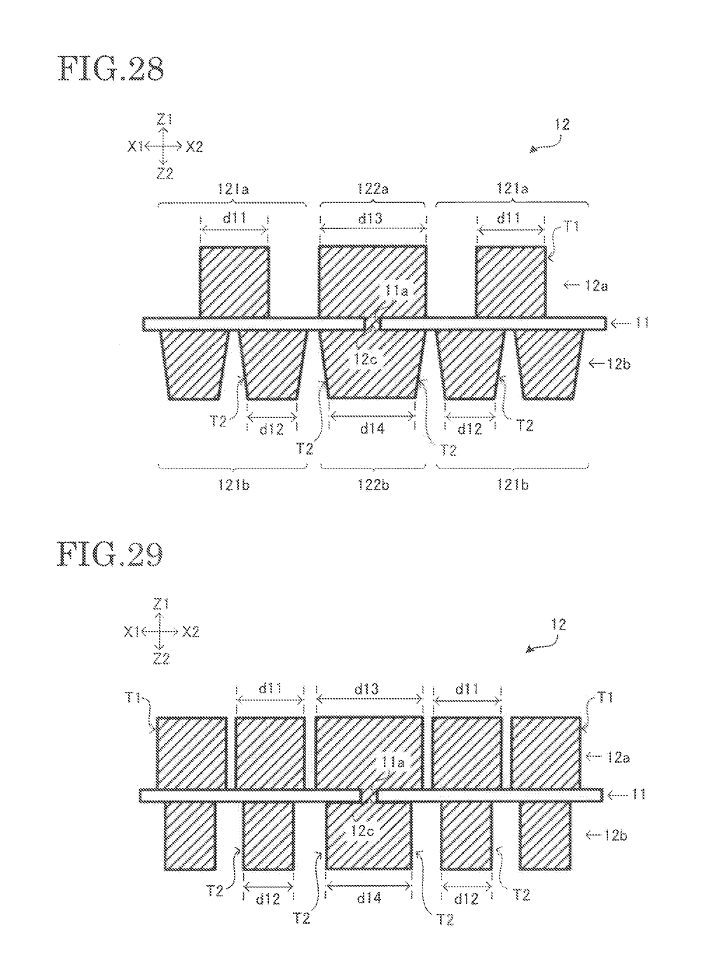

As shown in FIG. 29, in spiral pattern 12, conductors in first conductive pattern (12a) and second conductive pattern (12b) formed on the first surface and the second surface of insulative substrate 11 may each have side surfaces (T1, T2) which are substantially perpendicular to the main surfaces of insulative substrate 11. However, in such a case, widths (d12, d14) at the tip of the conductors in second conductive pattern (12b) are set narrower than widths (d11, d13) at the base end of the conductors in first conductive pattern (12a) (d12<d11, d14<d13). If widths at the tip of the conductors in second conductive pattern (12b) are set narrower than widths at the base end of the conductors in first conductive pattern (12a), adjacent conductors in second conductive pattern (12b) may be prevented from touching each other when coil sheet 10 is bent or curved. Thus, the percentage of space that conductors occupy in the cross section of a coil increases, and the space factor may be improved. In short, as long as at least widths at the tip of the conductors in second conductive pattern (12b) are set narrower than widths at the base end of the conductors in first conductive pattern (12a), effects such as improvement in the space factor may be expected. Thus, the width at the base end of conductors in second conductive pattern (12b) may be set greater than the width at the base end of conductors in first conductive pattern (12a). The same applies to spiral pattern 13.

Regarding other factors, the structures of coil sheet 10, motor 100 or the like (elements, measurements, material, configuration, number of layers, positions and so forth) may be modified freely within a scope that does not deviate from the gist of the present invention.

In the above embodiments, a coil sheet with two laminate layers was shown as an example. However, a coil sheet with three or more laminate layers may also be used. For example, coil sheet 10 may be folded into three or more layers.

The number of spiral patterns (12, 13) is not limited specifically. For example, if coil sheet 10 is used without being folded (laminated), spiral patterns 13 may be omitted and only spiral patterns 12 may be arranged on insulative substrate 11.

Coil sheet 10 in the first embodiment may be used for purposes other than motors. Curving is not always required at the time of use.

Manufacturing methods in the present invention are not limited to the contents and order shown in the above embodiments. The contents and order may be modified freely within a scope that does not deviate from the gist of the present invention. Also, unnecessary steps may be omitted according to usage requirements or the like.

A method for forming tapered side surfaces (T2) is not limited to the method using tapered resist layers (24, 25) (see FIGS. 13, 14). In the following, an example of other such methods is described.

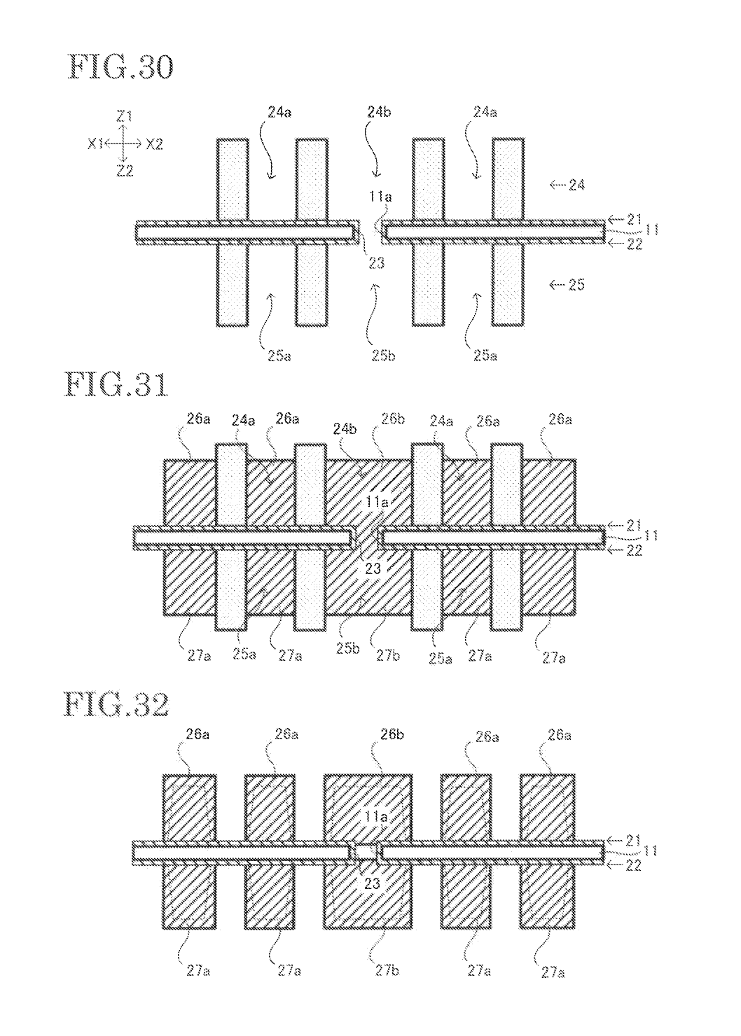

For example, after the step shown in FIG. 12, as shown in FIG. 30, straight-shaped resist layers (24, 25) (plating resists) are formed using resin for stereolithography, for example, instead of tapered resist layers (24, 25).

Next, as shown in FIG. 31, electrolytic copper plating is performed, for example. In doing so, electrolytic plated layer (26a) is formed in opening portions (24a); electrolytic plated layer (26b) is formed in opening portion (24b); electrolytic plated layer (27a) is formed in opening portions (25a); and electrolytic plated layer (27b) is formed in opening portion (25b).

After that, as shown in FIG. 32, resist layers (24, 25) are removed. Next, angular portions or the like of electrolytic plated layers (26a, 26b, 27a, 27b) are shaved by etching, and as previously shown in FIG. 16, first seed layer 21 and second seed layer 22 are removed while side surfaces (T2) are tapered. While electrolytic plated layers (26a, 26b, 27a, 27b) are etched throughout, their angular portions are especially etched. Thus, side surfaces (T2) will taper. Using such a method, tapered side surfaces (T2) may also be formed in second conductive pattern (12b) or the like.

A coil sheet according to one aspect of the present invention has the following: an insulative substrate which may be bent or curved and refers to either the upper surface or the lower surface as a first surface and to the other as a second surface; a first spiral conductive pattern formed on the first surface of the insulative substrate; and a second spiral conductive pattern formed on the second surface of the insulative substrate. In such a coil sheet, the width at least at the tip of a conductor in the second conductive pattern is set narrower than the width at the base end of a conductor in the first conductive pattern.

A method for manufacturing a coil sheet according to another aspect of the present invention includes the following: preparing an insulative substrate which may be bent or bent or curved and refers to either the upper surface or the lower surface as a first surface and to the other as a second surface; and forming a first spiral conductive pattern on the first surface of the insulative substrate and a second spiral conductive pattern on the second surface of the insulative substrate in such a way that the width at least at the tip of a conductor in the second conductive pattern is set narrower than the width at the base end of a conductor in the first conductive pattern.

Obviously, numerous modifications and variations of the present invention are possible in light of the above teachings. It is therefore to be understood that within the scope of the appended claims, the invention may be practiced otherwise than as specifically described herein.

What is claimed is:

1. A coil sheet, comprising:
an insulative substrate configured to be bent and having a first surface and a second surface on an opposite side of the first surface;
a first conductor forming a first spiral conductive pattern and formed on the first surface of the insulative substrate; and
a second conductor forming a second spiral conductive pattern and formed on the second surface of the insulative substrate,
wherein the second conductor of the second spiral conductive pattern has a tip portion having a width which is set narrower than a width of a base end portion of the first conductor of the first spiral conductive pattern.

2. The coil sheet according to claim 1, wherein the first conductor of the first spiral conductive pattern and the second conductor of the second spiral conductive pattern face each other by sandwiching the insulative substrate.

3. The coil sheet according to claim 1, wherein the second conductor of the second spiral conductive pattern has a side surface which inclines inward from a base end portion of the second conductor toward the tip portion of the second conductor.

4. The coil sheet according to claim 3, wherein the first conductor of the first spiral conductive pattern has a side surface which inclines inward from the base end portion of the first conductor toward a tip portion of the first conductor.

5. The coil sheet according to claim 1, further comprising a third conductor forming a third spiral conductive pattern and formed on the second surface of the insulative substrate, and a fourth conductor forming a fourth spiral conductive pattern and formed on the first surface of the insulative substrate, wherein the fourth conductor of the fourth spiral conductive pattern has a tip portion having a width which is set narrower than a width of a base end portion of the third conductor of the third spiral conductive pattern.

6. The coil sheet according to claim 5, wherein the first spiral conductive pattern and the second spiral conductive pattern are positioned on one side of a border line on the insulative substrate, and the third spiral conductive pattern and the fourth spiral conductive pattern are positioned on the other side, and when the insulative substrate is folded at the border line, the second spiral conductive pattern, the first spiral conductive pattern, the fourth spiral conductive pattern and the third spiral conductive pattern are overlapped in an order of the second spiral conductive pattern, the first spiral conductive pattern, the fourth spiral conductive pattern and the third spiral conductive pattern.

7. The coil sheet according to claim 5, wherein the first conductor forming the first spiral conductive pattern is provided in a plurality, the second conductor forming the second spiral conductive pattern is provide in a plurality, the third conductor forming the third spiral conductive pattern is provided in a plurality, the fourth conductor forming the fourth spiral conductive pattern is provided in a plurality, the first spiral conductive patterns have centers between which a distance is set shorter than a distance between centers of the fourth spiral conductive patterns, and the second spiral conductive patterns have centers between which a distance is set shorter than a distance between centers of the third spiral conductive patterns.

8. The coil sheet according to claim 1, wherein the insulative substrate bends in a bending direction, the first spiral conductive pattern and the second spiral conductive pattern form a spiral pattern in substantially a parallelogram shape, and two sides of the substantially parallelogram shape are set substantially parallel to the bending direction and the other two sides of the substantially parallelogram shape do not intersect with the bending direction at a right angle.

9. A method for manufacturing a coil sheet, comprising:
preparing an insulative substrate which bends and has a first surface and a second surface on an opposite side of the first surface; and
forming a first conductor forming a first spiral conductive pattern on the first surface of the insulative substrate and a second conductor forming a second spiral conductive pattern on the second surface of the insulative substrate such that the second conductor of the second spiral conductive pattern has a tip portion having a width which is set narrower than a width of a base end portion of the first conductor in the first spiral conductive pattern.

10. The method for manufacturing a coil sheet according to claim 9, further comprising after the preparing of the insulative substrate and before the forming of the first conductive pattern and the second conductive pattern, forming a first seed layer on the first surface of the insulative substrate and forming a second seed layer on the second surface of the insulative substrate, wherein the first conductive pattern and the second conductive pattern are formed by forming on each of the first seed layer and the second seed layer a resist layer having side surfaces which incline inward toward the insulative substrate, by forming an electrolytic plated layer on areas of the first seed layer and the second seed layer where the resist layer is not formed, and by removing the resist layer, the first seed layer and the second seed layer.

11. A coil sheet holder, comprising:
a cylindrical holding member; and
sheet according to claim 1 which is attached to an inner surface of the cylindrical holding member.

12. The coil sheet holder according to claim 11, wherein the coil sheet is bent along the inner surface of the cylindrical holding member while the coil sheet is folded to be double-layered or more.

13. A method for attaching a coil sheet, comprising:
preparing a coil sheet according to claim 1;
bending the coil sheet while being folded to be double-layered or more and attaching the coil sheet to a thermally expandable support rod;
inserting the support rod with the attached coil sheet into a cylindrical holding member; and
attaching the coil sheet to an inner surface of the cylindrical holding member by heating the support rod and pressing the coil sheet against the inner surface of the cylindrical holding member using expansion force of the support rod.

14. A motor rotor, comprising:
a rotating shaft; and
a coil sheet according to claim 1 attached to an outer surface of the rotating shaft.

15. A motor, comprising:
a rotating shaft;
a magnet attached to the rotating shaft;
a cylindrical member in which the rotating shaft is inserted; and
a coil sheet according to claim 1 attached to the cylindrical member and positioned between the magnet and the cylindrical member.

16. A motor, comprising:
a rotating shaft;
a cylindrical member in which the rotating shaft is inserted; and
a coil sheet according to claim 1 attached to the rotating shaft and positioned between the rotating shaft and the cylindrical member.
